(19) United States
(12) Patent Application Publication
(10) Pub. No.: US 2025/0272145 A1
(43) Pub. Date: Aug. 28, 2025

(54) SYSTEMS AND METHODS FOR HETEROGENEOUS LARGE LANGUAGE MODEL ENCODER AND DECODER PROCESSING

(71) Applicant: Expedera, Inc., Santa Clara, CA (US)

(72) Inventors: Shang-Tse Chuang, Los Altos, CA (US); Siyad Chih-Hua Ma, Palo Alto, CA (US); Costas Calamvokis, Bath (GB); Sharad Vasantrao Chole, San Jose, CA (US)

(21) Appl. No.: 19/059,789

(22) Filed: Feb. 21, 2025

Related U.S. Application Data
(60) Provisional application No. 63/557,418, filed on Feb. 23, 2024.

(51) Int. Cl. G06F 9/50

(52) U.S. Cl. CPC G06F 9/5016; G06F 9/5027

(57) ABSTRACT

Systems and methods are disclosed for efficient memory allocation for processing large language model encoders and decoders based on an attention model. The system can utilize a plurality of two types of processors suitable for different types of LLM processing. These include Neural Processor Units and Graphic Processing Units. Each NPU processor has dedicated DDR memory coupled to each NPU. The DDR memory caches the neural network weights used in the generation of neural network activations. A plurality of GPUs provides KVQ token processing. LLM tokens processing can be performed in parallel batches or sub-batches to utilize idle NPU processors within the neural network. In some embodiments, the NPUs are structured in a matrix with a bus between adjacent processors. In another embodiment, NPUs provide both KVQ processing and neural network processing. The system can be integrated on a silicon substrate using chiplets in a 2.5 or 3-D architecture.

### CROSS REFERENCE TO RELATED APPLICATIONS

This non-provisional application claims the benefit and priority of U.S. Provisional Application Ser. No. 63/557,418, filed on Feb. 23, 2024, entitled “SYSTEMS FOR HETEROGENEOUS LARGE LANGUAGE MODEL ENCODER AND DECODER PROCESSING,” all of which are hereby incorporated herein by reference, including all appendices as if fully set forth herein.

### TECHNICAL FIELD

The present application relates to the field of large language model processing. More specifically, the application relates to semiconductor systems and methods for efficient processing based on an attention mechanism, a large language model connected with an encoder and/or decoder using a lower-cost memory architecture.

### BACKGROUND

It should not be assumed that any of the approaches described in this section qualify as prior art merely by virtue of their inclusion in this section. The paper “Attention Is All You Need” by Ashish Vaswani et al., published at the 31st Conference on Neural Information Processing Systems (NIPS 2017), Long Beach, CA, provides a Transformer network architecture based solely on attention mechanisms and is incorporated herein by reference. The provided attention mechanism dispenses with recurrence and convolutions and thus provides a Transformer architecture that more efficiently provides a longer window to reference from than Recurrent Neural Networks, Gated Recurrent Units (GRUs), or Long Short-term Memory (LSTM).

The attention processing mechanisms are memory access intensive. Thus, there is a need for memory architectures for attention-based systems that are cost-effective and efficient.

### SUMMARY

Systems and methods are disclosed for a memory architecture for processing large language model transformers based on attention processing. The system includes a plurality of Neural Processing Unit (NPU) and Graphic Processing Unit (GPU) processors with a plurality of dedicated weight buses coupled to DDR memories. Each of the plurality of Double Data Rate (DDR) memories is coupled to an NPU/GPU processor. Each of the DDR memories can store code for executing a transformer function by the NPUs/GPUs and caches weights used by the NPUs/GPUs to compute one or more neural network activations. These weights are divided between the DDR memories to balance the neural network processing load. Communication between each NPU/GPU processor and the DDR memories is provided using a dedicated weight bus.

The systems and methods also include a plurality of GPU processors, a plurality of NPU/GPU memories, each of the plurality of High Bandwidth Memories (HBM) coupled to the plurality of GPU processors, and each of the pluralities of HBM memories storing a program executable by each of the plurality of GPU processors to compute one or more key, value, query (KVQ) values. Further, the HBM memory provides a cache of all or part of the calculated KVQ values generated by GPU processors associated with token processing. A Peripheral Component Interconnect Express (PCIe) bus coupled to each of the plurality of GPU/NPU processors provides communication for loading neural weights, KVQ cache values, executable code for the NPUs and GPUs, and communicating activation values between NPU/GPU processors.

### BRIEF DESCRIPTION OF THE DRAWINGS

Exemplary embodiments are illustrated by way of example and not limited by the figures of the accompanying drawings, in which like references indicate similar elements.

FIG. 1A—Shows a sentence that can be tokenized.

FIG. 1B—Shows the sentence of FIG. 1A tokenized into tokens.

FIG. 2—Shows a block diagram of the Input Embedding of tokens generating input vectors.

FIG. 3A—Shows a block diagram of multi-headed attention processing.

FIG. 3B—Shows a block diagram of Transform Block processing.

FIG. 4—Illustrates the computation process and caching of the (Q*KAT)*V computation.

FIG. 5A—Illustrates a block diagram of one embodiment of the processing architecture for processing based on an attention mechanism for large language models.

FIG. 5B—Illustrates a block diagram of another embodiment of the processing architecture for processing based on an attention mechanism for large language models.

FIG. 5C—Illustrates a block diagram of another embodiment of the processing architecture for processing based on an attention mechanism for large language models.

FIG. 6—Is a flow diagram of a method for balancing the memory loading within a Large Language Model (LLM) system based on attention processing.

### DETAILED DESCRIPTION OF EXAMPLE EMBODIMENTS

The following detailed description includes references to the accompanying drawings, which are a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, functional, logical, and electrical changes can be made without departing from the scope of what is claimed. The following detailed description is, therefore, not to be taken in a limiting sense, and the scope is defined by the appended claims and their equivalents.

At a high level, Large Language Models (LLMs) are generally built using a number of transformer layers. The job of the LLM is to predict the next token in a sequence of tokens. A token roughly corresponds to a word, but sometimes a word might translate to multiple tokens. The sequence of tokens that make up the prompt are fed into the LLM; then the LLM starts generating its answer one token at a time. After a token is generated, it is fed back into the LLM so that the LLM knows what tokens it has already generated.

Within the LLM, the token is mapped into a long list of numbers known as an embedding (e.g. 8192 numbers). This embedding is then mapped in various ways into other long lists of numbers. These are known as activations.

A transformer layer is itself made up of a number of layers, the most important of which are the Multi-Headed Attention Layer, the fully connected layer, and the linear layers.

The Multi-Headed Attention layer's job is to relate the current input token to the previous tokens the LLM has seen and has generated. To make this task practical, there is a limit on how far the attention goes back into the past. This is known as the context window. The Multi-Headed

Attention starts by mapping the input token's embedding into three different activations called the Key (K), Value (V), and Query (Q). The next step is to perform a mathematical operation on the current Query and all the previous Keys and Values in the context window. Note that in order to do this, we need to either recalculate the previous Keys and Values for all the embeddings in the context window or store all the previous Keys and Values in the context window. The latter option is much more preferable, especially for long context windows. The store of the Keys and Values is called the KV cache.

The fully connected layer is a type of neural network that contains a large number of parameters (also known as weights) that process the input activation and turn it into an output activation. These parameters are learned during training and do not change during operation. These parameters form most of the parameters in the LLM.

The rate that an LLM can generate a response is limited by the time it takes to process a token through the whole network because each token depends on the previous token. So, processing must be performed serially with only one new token for the stream, being worked on at any one time.

To increase the throughput of the LLM we use a technique called batching, where the LLM processes multiple streams at once. So, the LLM can handle queries from multiple users at once. Thus, although the rate of each single stream is not increased, the total rate at which tokens are generated is increased by the batch size.

If we look at the batches in the Feed Forward Network part of the LLM, we see that all the batches use the same parameters. Thus, there is no extra cost in terms of memory bandwidth to increase the batch count. The extra batches consume processing power, but it is possible to provision sufficient processing power for quite high batch counts.

The KV cache, however, does have to store all the values independently for all sessions within a batch. Thus, the size of the KV cache needed is directly proportional to the batch size. As the whole of the KV cache must be read for each batch's worth of tokens generated, this increase in batch size also increases the memory bandwidth needed.

So, for high batch counts, large KV caches are required, therefore requiring large memories. Because of the high memory utilization of the KV caches, high bandwidth memory is preferred, but other memory can be used, including but not limited to DDR memory. In contrast, the Feed Forward Network requires lower bandwidth. Thus, in order to build a system that makes optimal use of memory bandwidth, we place the KV cache into a high bandwidth (and high cost) memory and the parameters into a lower bandwidth (and lower cost) memory. These two types of memories are connected to different chips, and then the work is distributed across those chips in an interleaved manner as the processing moves from Attention to Feed Forward as each transformer layer is processed.

In another embodiment, the system may be processing a session that is not currently active. Thus, it is not the best use of expensive high-bandwidth memory to store KV cache values for an inactive session. These KV cache values for the inactive sessions can be moved to less expensive but slower DDR memory. When the session becomes active, the KV cache can then be moved back to the high-bandwidth memory.

Large Language Models can be trained with different data sets to address different problems, specialized solutions, and technical areas. Thus, an LLM trained for one problem or solution area will have different requirements for a KV cache size and for weights used for linear processing, including the trained neural network. Further, the utilization of the KV cache can vary depending on whether the system supports multiple batch processing. In some embodiments, a system can provide NPU and GPU processors and memory coupled to the processors as resources allocated to an LLM with particular characteristics.

Thus, knowing in advance the characteristics of the LLM, the required number and types of processors and memories, including the processor's speed and memory sizes, can be determined or estimated in advance. The examples given above are illustrative of different workloads resulting in different optimized solutions. Other workloads (with different mixes of active sessions, inactive sessions, and KV cache size distributions) can give rise to other optimized solutions when taking into account the relative cost and/or power consumption of the available processing and memory devices. These LLM solutions could be picked ahead of time by analyzing the projected workload to determine how much memory storage, memory bandwidth, and processing power each step requires and assigning it to the appropriate processor and memory device or group of processors and memory devices. The appropriate device is determined by modelling its performance under a particular load.

This technique is generally applicable for any AI task where there is memory bandwidth that is independent of batching mixed with memory bandwidth that depends on batching. It allows an optimal solution to be built, maximizing the batching while balancing the memory cost of each part of the system independently.

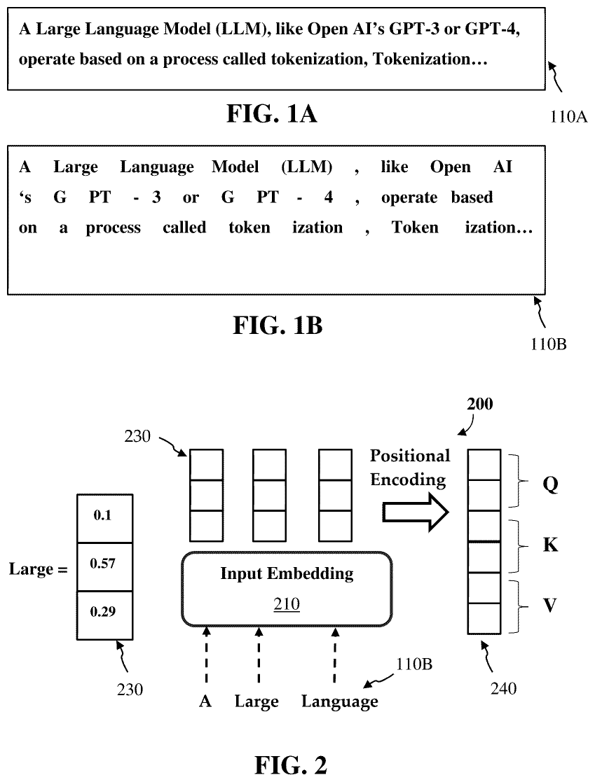

FIG. 1A shows “a sentence” 110A before tokenization for input to an LLM Transformer. A sentence such as the one shown in FIG. 1A can be input into a Transformer Machine based on an attention mechanism after tokenization. Examples of Transformer Machines include chat bots like ChatGPT-3 and ChatGPT-4.

FIG. 1B shows the sentence 110A after being tokenized. The tokens 110B are input into

a Transformer Machine based on an attention mechanism after tokenization. Some words can become a token.

FIG. 2 shows the encoding 200 of tokens 110B using input embedding 210 into a word embedded layer 240. The word embedded layer 240 encodes a representation of the tokens into numbers 230. The word embedded layer 240 numbers include a vector representation of the word and positional information of the tokens.

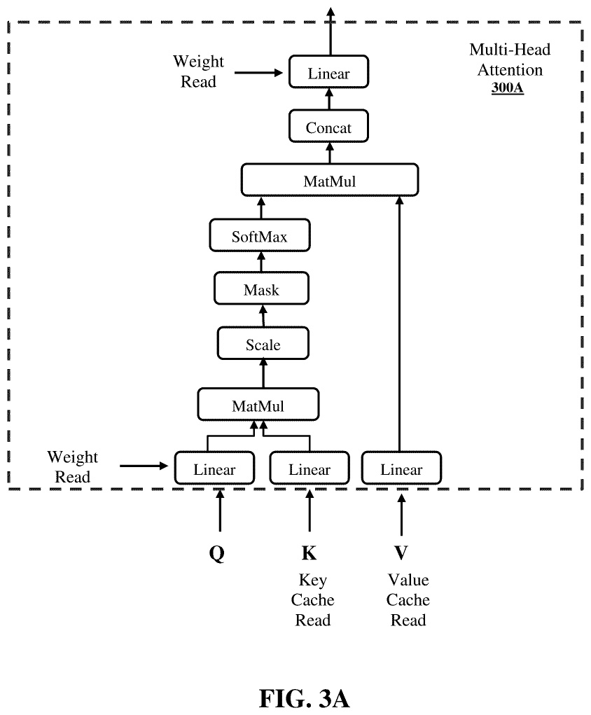

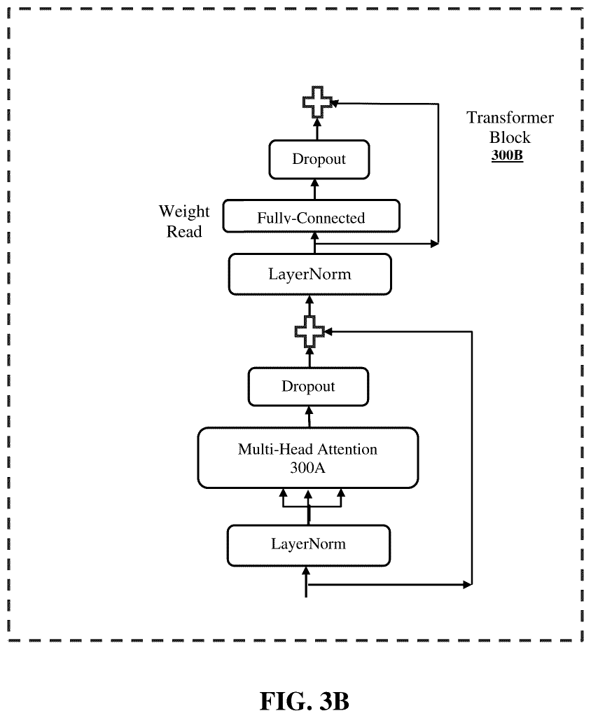

FIG. 3A shows the processing components of a multi-headed attention 300A model. In the shown embodiment, the attention mechanism generates self-attention where the model provides an association for each token with each of the other tokens in the input. The inputs to the first “Linear” layer are the Q, K, and V vectors. These represent the Query, Key, and Value inputs. The query and key undergo a dot-product multiplication to generate a scores matrix. The scores matrix determines how much focus should be put on other input words. Then, the scores get divided down by the dimension of the keys. This step is performed to prevent exploding gradients. Next, a SoftMax is performed on the normalized scores to generate probability values between zero and one. Next, the attention weights are multiplied by V, the value.

To make the model into a multi-headed computation, the Q, K, and V vectors need to be split into multiple vectors. Each of the vectors go through the same self-attention process individually. Each self-attention process is called a head. Each head generates an output vector, which are concatenated into a single vector before going into a linear layer. In theory, each head would learn something different, therefore giving the encoder model more representation capability.

FIG. 3B shows a block diagram of the processing components for performing a

Transformer block 300B. Functions, such as a Transformer, can be performed across multiple processors where each of the processors has dedicated memory depending on the requirements for reading and writing to memory.

In some embodiments, batches of inputs can be processed. Some of the Transformer functions utilize the same weights, so the accessing of memory is low, while other functions require a large amount of memory and a high memory access requirement. For example, in the shown Transformer block 300B, the multi-headed attention 300A processing can utilize a separate memory and generate a high memory access rate. In another embodiment, the memory can be shared with other processes. This processing would be allocated to a processor with a High Bandwidth Memory (HBM). Using a processing function, such as fully connected component, the weights can be constant, and the processing function can be allocated to a processor with slower and lower-cost memory such as Double Data Rate (DDR) memory.

In the example shown, batch input processing can be implemented. Some of the functions, such as the fully connected layer, where the weights do not change between different inputs, can be shared. Thus, the memory reads can be shared across batch inputs and utilize lower cost and slower memory.

In summary, multi-headed attention is a module in a transformer network that computes the attention weights for the input tokens and produces an output vector with encoded information on how each token should attend to each of the other words in the sequence.

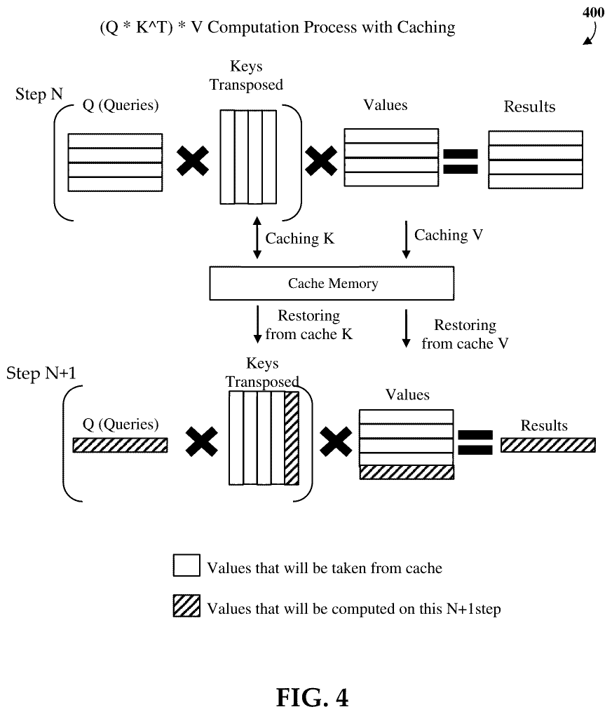

FIG. 4 shows the processing flow and the use of the KV cache. As each new token is processed, step N+1, only one new (Q*K\hat{ }T) vector needs to be processed. The value is added to the KV cache. Further, the new V (value) is added to the KV cache.

FIG. 4 shows the matrix processing and flow of data 400 from cache memory for the (Q*K\hat{ }T)*V processing of Q, K, and V matrixes. As shown in the N+1 step, when a new query is calculated, only one new (Q*K\hat{ }T) dot-product needs to be calculated for the new Q vector. Thus, most of the Q*K results can be read from cache memory. This results in a large memory read demand, also known as pressure, and much fewer write cycles.

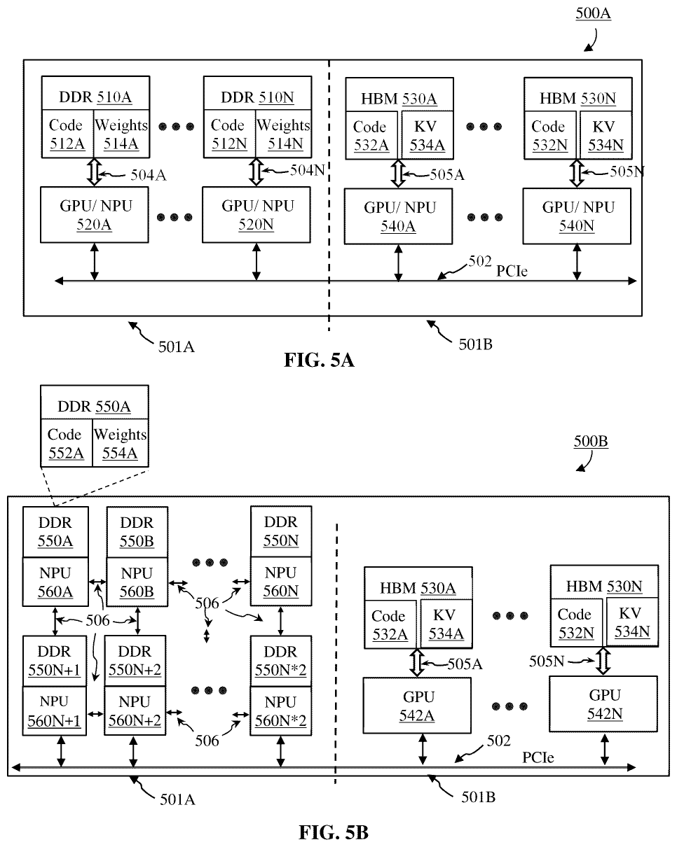

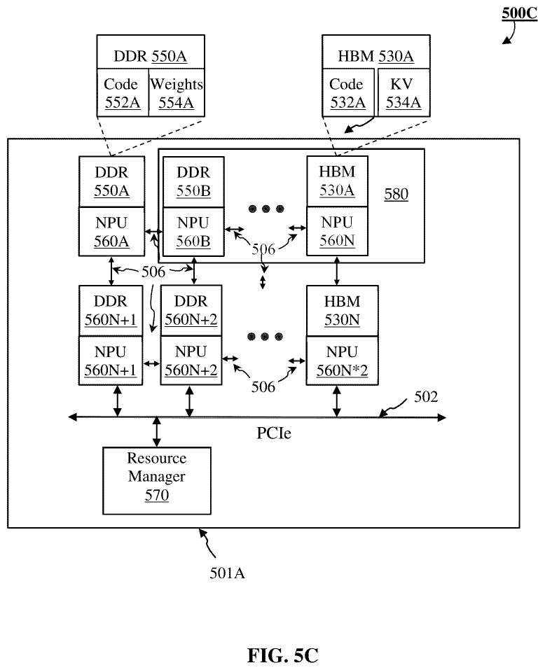

FIG. 5A shows a novel embodiment of a processor memory architecture 500A, where one processing set of functions are processed by one set of processors 520A-N utilizing one type of memory 510A-N and another set of processors 540A-N processing another set of functions utilizing another type of memory 530A-N. The processors can be of the same type or different types, including but not limited to custom or commercial Neural Processing Units (NPUs) or commercial or custom Graphic Processing Units (GPUs). The memories 510A-N and 530A-N and processors 520A-N and 540A-N can be chiplets mounted on one or more silicon substrates 501A-B. The substrates 501A-B can be a continuous substrate or multiple substrates. The chiplets can include a plurality of processors (NPU/GPU) with one or more buses to interconnect with memory and other processors. The silicon substrate can be any suitable material. The most common substrate material used for semiconductor chiplets is silicon (Si), as it is the primary material for most semiconductor devices due to its excellent electrical properties, availability, and cost-effectiveness; however, depending on the application, other materials like silicon carbide (SiC) or gallium arsenide (GaAs) might be used for specialized chiplets requiring high power or high frequency capabilities.

When referencing the component “memory”, or a “memory type”, this reference, refers to a block of memory that is only accessible by a processor or a set of processors over a dedicated bus. However, in some embodiments, a processor can be a cluster or matrix of processors, including but not limited to NPUs and GPUs. The size of the “memory” can range from kilobytes to gigabytes. The memory width can be multiple bytes wide or any number of bits. The “memory” can be formed on a semiconductor chip with the processors or be formed on a separate chiplet that is bonded to a substrate 501A-B in a 2.5D or 3D architecture.

In LLM models, some processing functions require high access to memory. In a system providing LLM processing, processors that process functions requiring high-speed access are tied to faster memories but more expensive memories. One example, but not by way of limitation, is High Bandwidth Memory (HBM). This memory can be coupled to a GPU, NPU, or other suitable processors. Processing functions that have larger memory requirements or may require less memory bandwidth can use less expensive memory. DDR memory is one option for less expensive large memory suitable for this type of processing. DDR memory includes the different generations of DDR memory, including DDR2, DDR3, DDR4, and DDR5.

The transformer blocks of an LLM include processing of a fully connected neural network. When in use by an LLM model, these neural networks are typically previously trained. The token processing requires a high memory bandwidth to read the neural weights used to generate neural network activations. As shown in FIG. 5A, the neural weights 514A-N are fully or partially cached in the DDR memories 510A-N. Using the code for the transformer blocks, the processors 520A-N can provide the neural network and other transformer block processing for the LLM.

The processors 520A-N, which provide the neural network processing, can be divided up to provide activations by neural network layer, or divided up to provide one or more activations by a processor within the neural network. For best processing throughputs, the processors 520A-N will be generating approximately the same number of neural activations. This can vary if a neural network node has more weight inputs than other nodes.

Because some processes, like the Transformer LLM, are serial processes, there can be idle time for some of the processors 520A-N. The neural network activations flow from processor to processor.

Thus, the processors 520A-N can be utilized more effectively by dividing a batch of inputs into multiple sub-batches. These sub-batches can be scheduled on the relevant processing engine, the NPU or GPU for example, to keep the processors 520A-N busy. This can reduce the memory demand needed to reload neural network weights into the memories 510A-N for the NPU/GPU processors 520A-N. Thus, this architecture can take advantage of utilizing existing NPU/GPUs 520A-N while adding processing resources through the PCIe bus 502.

For example, when the processor 520A is done computing activations for one token, the processing for the rest of the neural network needs to be completed by the other processors 520B-N. This leaves the processor 520A idle while waiting for the completion. Thus, the processor 520A is available to start processing a token in another batch. Alternatively, the processor 520A can start processing the next sub-batch or portion of a sub-batch.

The communication between the DDR memories 510A-N and the processors 520A-N can be through dedicated buses 504A-N. This bus can be a standard bus for interfacing with DDR memory or can be a custom bus compatible with the DDR memories 510A-N and the processors 520A-N. Communication between the HBM memories 530A-N and the processors 540A-N can utilize buses 505A-N or custom interfaces.

Communication between processors can be provided by a bus 502 coupled to each of the processors. This bus 502 can be used to load LLM processing codes 512A-N, 532A-N, neural network weights 514A-N, and KV cache values 534A-N into the memories 510A-N. Further, activations generated by the processors 520A-N are transferred to the other processors 520A-N using the bus 502. In one embodiment, the bus 502 is a PCIe bus. The loading of weights, a portion of the weights, and code can utilize other processors and systems (not shown) and from storage devices (not shown) coupled to the bus 502.

The LLM processing architecture, shown in FIG. 5A, includes KVQ calculations. These calculations are allocated to processors (GPUs/NPUs) 540A-N, which utilize HBM memories 530A-N through local HBM buses 505A-N. The KVQ calculations are very memory and processing intensive. Thus, it is efficient to cache the KVQ values in a KV cache 534A-N, which is updated as each new token from each batch is processed. If the processors 540A-N are GPUS, these graphic processors are commonly found on chips or chiplets made by NVIDIA®.

FIG. 5B shows another embodiment 500B of a memory architecture of the inventive concept. In this memory and processor architecture, the transformer processors are NPU processors 560A-N*2 forming matrix of processors 560A-N*2 and associated memory 550A-N*2. Each NPU processor 560A-N*2 can have dedicated inter-processor buses 506 to communicate with adjacent processors. The inter-processor buses are usually used to pass activations between the processors but can be used for other functions including but not limited to moving weights, executable code, and other control information. These connections can be a die-to-die connection. The DDR memories 550A-N*2 can be packaged on top of the NPUs. Again, processes that utilize the neural weights are allocated to the NPU processors, each having their own DDR memory. The memory-intensive processes, such as attention functions KVQ calculations, are allocated to the GPU processors 542A-N with the HBM memories 530A-N. The workflow process of the Transformer can flow from the NPUs to the GPUs over a PCIe bus 502 or other suitable bus.

As discussed above, the transformer blocks of an LLM include processing of a fully connected and trained neural network. The token processing requires a high memory bandwidth to read the neural weights used to generate neural network activations. As shown in FIG. 5B, the neural weights 554A-N*2 are fully or partially cached in the DDR memories 550A-N. For readability, not all of weights are shown in the DDR memories 550A-N*2. Using the codes 552A-N2, for the transformer block processing, the NPU processors 560A-N*2 can provide the neural network and other transformer block processing for the LLM.

The communication between each DDR memory 550A-N*2 and each of the NPU processors 560A-N*2 can be through a dedicated bus (not shown) similar to the dedicated buses 504A-N used in FIG. 5A. This bus can be a standard bus for interfacing with DDR memory or can be a custom bus compatible with the DDR memory 550A-N*2 and the NPU processors 560A-N*2. Communication between the HBM memories 530A-N and the processors 540A-N can utilize buses 505A-N or custom interfaces.

Communication between the NPU processors 560A-N*2 can be provided over a plurality of dedicated inter-processor buses 506. The plurality of dedicated inter-processor buses 506 can connect each NPU processor 560A-N*2 to all the adjacent NPU processors 560A-N*2. This architecture provides flexibility in allocating neural network processing tasks to the NPU processors 560A-N*2 and flexibility in communicating the generated activation value between the NPU processors 560A-N*2. Further, the dedicated inter-processor buses 506 can utilized in loading the NPU's code 552A and neural weights 554A. As discussed in FIG. 5A, the loading of weights, a portion of the weights, and code can be provided by other processors and systems (not shown) and from storage devices (not shown) coupled to the bus 502.

As discussed above for FIG. 5A, the KVQ calculations are performed by the GPU processors 542A-N. The GPU processors 542A-N are coupled to the memories 530A-N. The buses and processing are as described above for the processors 540A-N in FIG. 5A.

FIG. 5C shows a further novel embodiment 500C of the inventive concept. In this architecture, all the LLM neural network processing and KVQ calculation are performed by a matrix of NPU processors 560A-N*2. These calculations can be performed by custom processors or by NPU processors 560A-N*2. In this memory and processor architecture, the NPU processors 560A-N*2 each have dedicated inter-processor buses 506 to communicate with adjacent processors. Again, processes that utilize the same neural weight values are allocated to the NPU processors 560A-N*2 each having their own slower and less expensive memory DDR memory. Further, for the processes that are memory intensive, such as the calculating of the KV cache values 534A, NPU processors 560A-N*2 are coupled with the HBM memories 530A-N. In one embodiment, the HBMs 530A-N are chiplets mounted on the same substrate that includes the NPU processors 560A-N*2. Further, the DDR memories are also chiplets. In some embodiments, the NPU processors 560A-N*2 do not have all the same capability. For example, an NPU may have multiple cores that can range from eight to sixty-four. A plurality of NPU processors 560A-N*2 can be mounted on the same silicon substrate, and DDR memory can be mounted on top of the NPU processors 560A-N*2. This architecture has the advantage of using the same NPU which can simplify the integration onto a substrate 501A and for code development.

In another aspect of the shown embodiment, the system includes a resource management processor 570. Based on the specific LLM and the LLM's associated characteristics and expected utilization, the NPU processors 560A-N are managed as a resource pool. A group of processors 580 and their associated memories are allocated and configured to provide a specific LLM. Thus, a substrate 501A could have multiple different LLMs operating. This group 580 can be static or dynamic. If not all of the processors and associated memory are needed for a period of time, the stored KV cache values can be moved from a memory in the group 580 and stored elsewhere included within the memory of the resource management processor 570 or some storage (not shown) coupled to the system. An unused process within the group 580 can be moved back to a processor pool and used by another LLM that could be operating within the pool of processors.

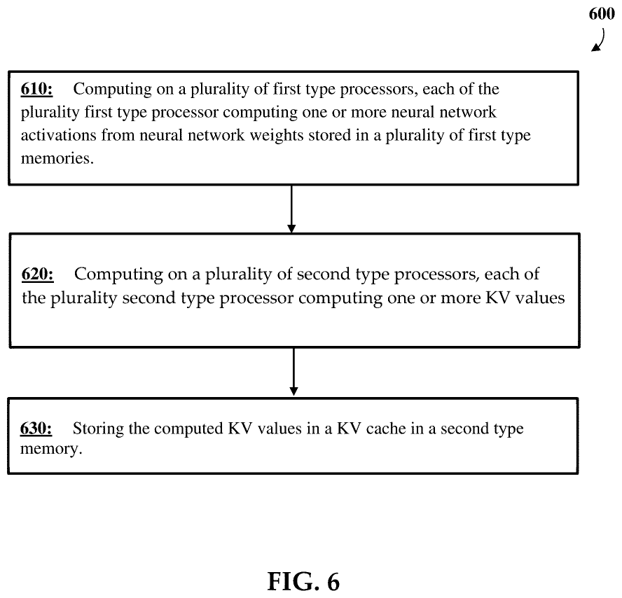

FIG. 6 shows a flowchart 600 of the method for balancing the memory loading within a system providing an attention processing encoder and decoder.

In step 610, the method comprises computing on a plurality of first type processors, each of the plurality first type processors computing one or more neural network activations from neural network weights stored in a plurality of first type memories. The neural weight values for generating the neural network activations can be allocated between the plurality of first type processors. Each of the plurality of first type processors can have a dedicated bus coupling one of the plurality of first type memories to the first type processor.

The generation of the one or more activations by each of the plurality of first type processors can be divided between the plurality of first type processors and the neural weights associated with computing the one or more activations by each of the plurality of first type processors are cached in the first type memory coupled with the first type processor over the dedicated bus.

The step 610 can include allocating across the plurality of first type processors and the associated first type memories the neural weights associated with token processing. Only activation information associated with the current token is transmitted between the plurality of first type processors.

In step 620, the KVQ values are computed on a plurality of second type processors, each of the plurality of second type processor computing one or more KV values. the KVQ values by the plurality of second type processors associated with token processing are cached in the plurality of second type memories of the second type.

In step 630, the computed KV values are stored in a KV cache distributed among a plurality of second type memories. The second type memories can be High Bandwidth Memory.

The corresponding structures, materials, acts, and equivalents of all means or step plus function elements in the claims below are intended to include any structure, material, or act for performing the function in combination with other claimed elements as specifically claimed. The description of the present technology has been presented for the purposes of illustration and description but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application and to enable others of ordinary skill in the art to understand the present technology for various embodiments with various modifications as are suited to the particular use contemplated.

Aspects of the present technology are described above with reference to flowchart illustrations and/or block diagrams of methods and apparatus (systems) according to embodiments of the present technology.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or combinations of special purpose hardware.

In the following description, for purposes of explanation and not limitation, specific details are set forth, such as particular embodiments, procedures, techniques, etc., in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment,” “in an embodiment,” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms, and a plural term may include its singular form. Similarly, a hyphenated term (e.g., “on-demand”) may occasionally be interchangeably used with its non-hyphenated version (e.g., “on-demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments, the “means for” is expressed in terms of a mathematical formula, prose, or as a flow chart or signal diagram.

The terminology used herein is for the purpose of describing particular embodiments only and is not intended to be limiting of the invention. As used herein, the singular forms “a,” “an,” and “the” are intended to include the plural forms as well unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof.

It is noted that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purposes only and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

While various embodiments have been described above, it should be understood that they have been presented by way of example only and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for efficient memory allocation for a large language model encoder and decoder based on an attention processing mechanism comprising:
a plurality of first type processors;
a plurality of first type memories, each of the plurality of the plurality of first type memories coupled to the plurality of first type processors, and each of the plurality of first type memories storing weight values used by each of the plurality of first type processors to compute one or more neural network activations;
a plurality of second type processors;
a plurality of second type memories, each of the plurality of second type memories coupled to the plurality of second type processors, and each of the plurality of second type memories storing KV cache values used by the plurality of second type processors to compute the KV cache values; and
a first bus coupled to each of the plurality of first type processors and the plurality of second type processors.

2. The system of claim 1, wherein the weight values for generating the neural network activations are divided between the plurality of first type processors.

3. The system of claim 1, further comprising a dedicated inter-processor bus for each of the plurality of first type processors coupling one of the plurality of first type memories to one of each of the first type processors.

4. The system of claim 3, wherein the generation of the one or more activations by each of the plurality of first type processors are divided between the plurality of first type processors and the neural weights associated with computing the one or more activations by each of the plurality of first type processors are cached in the first type memory and exchanged between with the plurality of first type processors over the dedicated inter-processor bus.

5. The system of claim 3, wherein the neural weights associated with token processing are allocated across the plurality of first type processors and their associated first type memories and wherein only activation information associated with the current token is transmitted between the plurality of first type processors.

6. The system of claim 1, wherein the generation of the KV cache values by the plurality of second type processors associated with token processing are cached in the plurality of second type memories.

7. The system of claim 6, wherein only activation information associated with the current token is transmitted between the plurality of first type processors.

8. The system of claim 7, further comprising an activation bus, wherein the activation information is transmitted between the plurality of first type processors over the activation bus.

9. The system of claim 1, wherein the plurality of first type processors and the plurality of second type processors are the same type processor.

10. The system of claim 1, wherein the plurality first type memories are Double Data Rate (DDR) memory and plurality second type memories is High Bandwidth Memory (HBM) or the plurality of first type memories are HBM and the plurality of second type memories are DDR memory.

11. The system of claim 10, wherein the plurality of first type processors are neural processing units (NPUs) and the plurality of second type processors are graphic processing units (GPUs) or the plurality of first type processors are GPU and the plurality of second type processors are NPUs.

12. A method for balancing the memory loading within a system providing an attention processing encoder and decoder, the method comprising:
computing on a plurality of first type processors, each of the plurality of first type processor computing one or more neural network activations from neural network weights stored in a plurality of first type memories;
computing on a plurality of second type processors, each of the plurality second type processor computing one or more KV values;
storing the computed KV values in a KV cache in a second memory type;

13. The method of claim 12, further comprising, allocating the neural network weights used for generating the one or more neural network activations between the plurality of first type processors.

14. The method of claim 12, wherein each of the plurality of first type processors has a dedicated bus coupling one of the plurality of first type memories to the first type processor.

15. The method of claim 14, wherein the generation of the one or more activations by each of the plurality of first type processors are divided between the plurality of first type processors and the neural weights associated with computing the one or more activations by each of the plurality of first type processors are cached in the first type memory coupled with the first type processor over the dedicated bus.

16. The method of claim 15, further including allocating across the plurality of first type processors and the associated first type memories the neural weights associated with token processing, wherein activation information associated with the current token is transmitted between the plurality of first type processors.

17. The method of claim 16, wherein the generation of the KV values by the plurality of second type processors associated with token processing are cached in the plurality of second type memories and wherein only the activation information associated with the current token is transmitted between the plurality of first type processors.

18. A system for efficient memory allocation for a large language model encoder and decoder based on an attention processing mechanism comprising:
a plurality of first type processors, each first type processor coupled to a memory;
a plurality of second type processors, each second type processor coupled to a memory;
a resource manager configured to allocate a first group of first type processors from the plurality of first type processors and a second group of second type processors to a LLM processing subsystem based on the LLM model characteristics for utilizing KV cache memory and utilizing weight memory; and
a PCIe bus coupled to each of the group of first type processors and to each of the second group of second type processors.

19. The system of claim 18, wherein the memories are Double Data Rate (DDR) memory and High Bandwidth Memory (HBM).

20. The system of claim 19, wherein the plurality of first type processors are neural network processors units (NPUs) and the plurality of second type processors are graphic processor units (GPUs).
